(19) United States
(12) Patent Application Publication
(10) Pub. No.: US 2001/0025396 A1
(43) Pub. Date: Oct. 4, 2001

(54) Hinge, in particular for doors, windows or the like

(76) Inventor: Harald Sitter, Chables (CH)

Correspondence Address: WENDEROTH, LIND & PONACK, L.L.P., 2033 K STREET N. W., SUITE 800, WASHINGTON, DC, 20006-1021, US

(21) Appl. No.: 09/779,544

(22) Filed: Feb. 9, 2001

(30) Foreign Application Priority Data
Feb. 11, 2000 (CH) 0286/00

(51) Int. Cl. E05D 1/00; E06B 3/34

(52) U.S. Cl. 16/221; 49/381; 49/501

(57) ABSTRACT

The invention relates to a hinge, in particular for doors, windows or the like, with two hinge wings (1, 2) which can be fastened on a hinge bearer (11 or 12), wherein at least one hinge wing (1) is adjustable transversely to its installation plane (17) through two setting screws (21a, 21b) disposed offset in height, which can be screwed into the hinge bearer (11) of the hinge wing (1) transversely to its installation plane (17). By actuating the setting screws (21a, 21b) it is possible to adjust the premounted hinge readily and finely into a precisely vertical installation position.

The invention relates to a hinge, in particular for doors, windows or the like, with two hinge wings, attachable on a hinge bearer.

A hinge of this type is described in EP-OS 0 967 353. In the hinge described here one of the hinge wings is equipped with a setting pin with which the premounted hinge wing can be adjusted laterally with respect to its installation plane. Accordingly, the hinge wing is fixedly arrested against the seating face of the hinge bearer. If this seating face is not completely vertical, in the installed state an oblique position results with respect to the vertical, which position to a considerable extent impairs the function of the hinge.

The invention is based on the task of avoiding this disadvantage and accordingly propose a hinge of the above described type which in the premounted state, can readily and easily be brought into a precise vertical position.

This task is solved according to the invention thereby that at least one hinge wing is adjustable transversely to its installation plane by at least one adjustment means disposed so as to be offset in height, which can be fastened in the hinge bearer of the hinge wing transversely to its installation plane.

After the hinge wing has been loosely attached on its hinge bearer, by actuating the setting screws, used advantageously as adjustment means, it can be adjusted finely and without significant force expenditures transversely to its installation plane until it has attained is completely vertical position. If required it is also at any time possible to readjust the hinge in order to correct its vertical position as needed.

Within the scope of as simple as feasible an implementation and actuation, the invention provides that the setting screws form at the front face one support face each for the hinge wing and are accessible through bores or slots of the hinge wing. In this way it becomes possible to mount the setting screws independently of the hinge and, after installation of the hinge, to actuate them by means of a screw driver guided through the bores or slots of the hinge wing.

If the hinge is provided with a setting element for the lateral adjustment of the hinge wing in its installation plane, the setting screws in this case are accessible according to the invention through the slots of the hinge wings directed in the adjustment direction of the setting element, wherewith the adjustment of the hinge wing in its installation plane as well as also transversely to it becomes possible.

The setting screws are usefully implemented as countersunk screws with flat screw heads. In the simplest implementation they are wood screws which can be screwed directly into the hinge wing. In the case of hinge bearers comprised of soft wood the setting screws can advantageously be screwed into metal or plastic bushings which are set into the hinge bearer.

To attain a relatively large-area support face, according to the invention at least one further setting screw is further provided which can be screwed into the hinge bearer transversely to the installation plane of the hinge wing.

It is generally of advantage if the setting screws in the installed state are disposed symmetrically with respect to the center axis of the hinge wing.

In the following the invention will be explained in further detail in conjunction with an embodiment example. In the drawing depict:

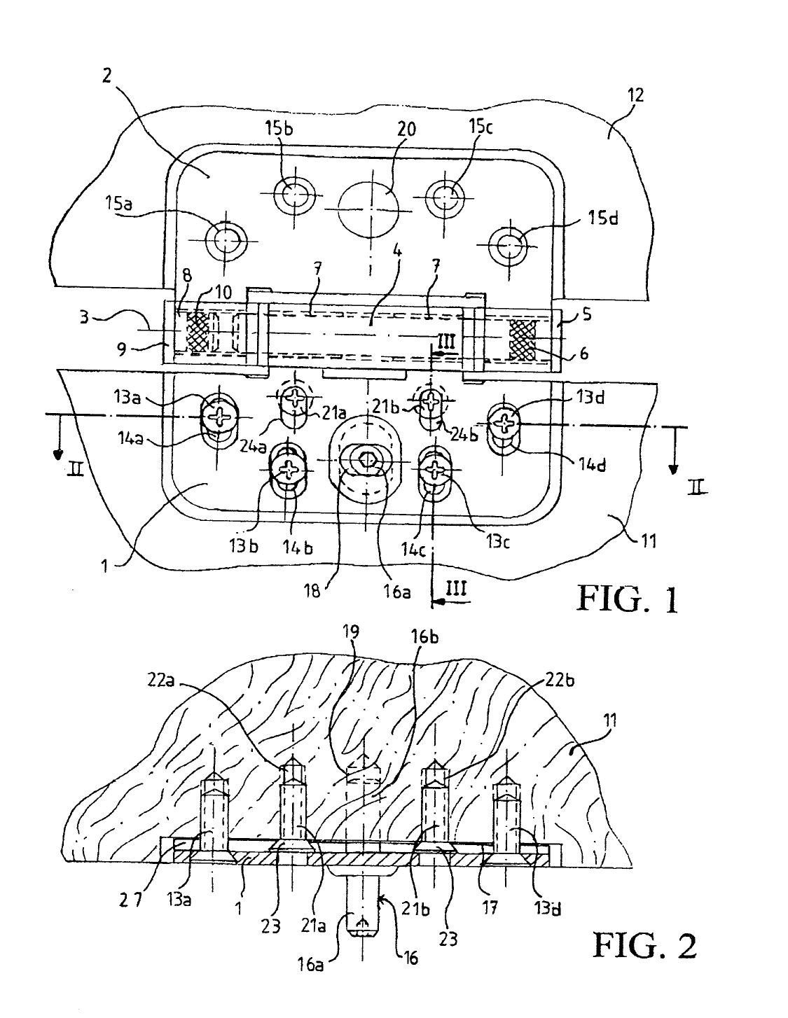

FIG. 1 a hinge according to the invention which can be adjusted laterally in its installation plane as well as also transversely to it, shown in top view,

FIG. 2 a section of the hinge along line II-II in FIG. 1, and

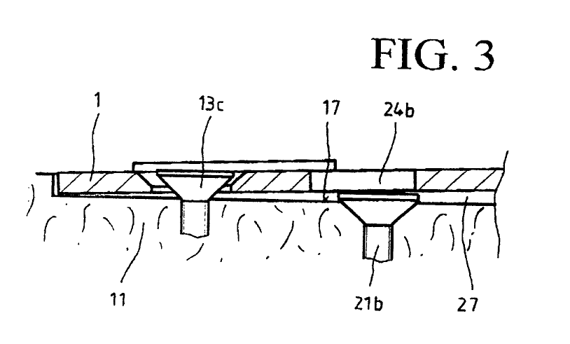

FIG. 3 a partial section of the hinge along line III-III in FIG. 1.

The hinge according to FIGS. 1 and 2 comprises two hinge wings 1 and 2, which can be pivoted relative to one another about a hinge axis 3. This is formed by a hinge bolt 4 with a flat head 5 and a knurled zone 6. In the hinge wings 1 and 2 are provided synthetic material bushings 7 as bearing for the hinge bolt 4. Into the lower synthetic material bushing is also inserted a plug 8 with flat head 9 and knurled zone 10.

The hinge wings 1 and 2 are fastened by means of fastening screws on a hinge bearer 11 or 12. The latter are, for example, a door frame and the associated door or a similar device. In the Figures only the fastening screws 13a, 13b, 13c and 13d of the hinge wing 1 are shown. To receive the fastening screws the hinge wings 1 and 2 comprise slots 14a, 14b, 14c and 14d or bores 15a, 15b, 15c and 15d.

An adjustment pin 16 with pin ends 16a and 16b, disposed eccentrically with respect to one another, serves for the lateral adjustment of the hinge wing 1 in its plane of installation which corresponds to the seating face 17 of the hinge wing 1 in the hinge bearer 11. The pin ends 16a and 16b are rotatably supported in a slot 18 of the hinge wing 1 or in a bore 19 of the hinge bearer 11. By rotating the adjusting pin 16 by means of a suitable tool the hinge wing 1, and thus the hinge, can be adjusted laterally in the direction of the longitudinal axis of the slot 18. With the hinge folded together the pin end 16a projects through a bore 20 of the hinge wing 2 into a receiving bore of the hinge bearer 12 and thereby acts as a mechanism preventing break-ins.

To adjust the hinge wing 1 transversely to its plane of installation, two setting screws 21a and 21b disposed offset in height are provided, which are screwed as simple wood screws into bores 22a or 22b of the hinge bearer 11 transversely to the installation plane 17 of the hinge wing 1.

The setting screws 21a and 21b are implemented as countersunk screws with flat screw heads 23, which at the front face form each one support face for the hinge wing 1 and are accessible through slots 24a and 24b in hinge wing 1. The longitudinal axis of slots 24a and 24b, as that of slots 14a, 14b, 14c, and 14d, is directed in the adjustment direction of the setting pin 16. The setting screws 21a and 21b and the slots 24a and 24b are disposed symmetrically with respect to the center axis of hinge wing 1.

Hinge wing 1 is depicted in the premounted position in FIGS. 1 and 2, in which it is loosely attached on hinge bearer 11 by means of fastening screws 13a, 13b, 13c and 13d on the seating face, forming the installation plane 17, of the hinge bearer 11. For an adjustment of the hinge transversely to the installation plane of hinge wing 1 it is only required to screw the setting screw 21a and/or the setting screw 21b so far into the bores 22a or 22b of the hinge bearer 11 until the desired completely vertical installation position of the hinge has been attained. A gap space 27 formed between the seating face of the hinge bearer 11 and the contact face of the hinge wing 1 facing it [the bearer] makes this adjustability of the hinge wing 1 possible. It is subsequently firmly fixed by tightening the fastening screws 13a to 13d.

FIG. 3 shows by example one possible position of the hinge wing 1 after it has been fixed in bearer 11. In order for a door or the like fastened on the hinge bearer 12 to be set precisely with respect to the, for example, one door frame provided [as] bearer 11, a position of the hinge wing 1 results which extends with its lower face slightly obliquely to the installation plane 17. At its end where it sits on bearer 11 the wing 1 could in principle also be provided with a cam elevation or an insert, such that it could therewith also be adjusted at a negative angle with respect to the installation plane 17.

In the embodiment example described the setting screws 21a and 21b are associated with the hinge wing 1. But it is also readily possible to provide corresponding setting screws for the hinge wing 2, wherein in this case the setting screws are not accessible through circular bores of the hinge wing 2 corresponding to the through-bores 15a to 15d for the (not shown) fastening screws of this wing. It is understood that it is also possible to equip both hinge wings simultaneously with corresponding setting screws.

In the embodiment example for the hinge wing 1 two settings screws 21a and 21b are provided such that the hinge wing 1 during the adjustment process is only stayed against the screw heads 23 of the two setting screws 21a and 21b. A support face of larger area is attained with at least one further setting screw disposed distributively on the face. If the hinge bearer 11 is comprised of a soft wood, metal or synthetic bushings are emplaced in a bore into hinge wing 11, into whose bores—corresponding to bores 22a and 22b—the setting screws 21a and 21b are screwed.

With this embodiment example the invention is sufficiently explained. It is understood that the configuration according to the invention could have a different appearance depending on the application purpose. Instead of the setting screws, in principle also a different adjustment means could be provided such as for example a ratched or snap catch.

1. Hinge, in particular for doors, windows or the like, with two hinge wings (1, 2) pivotable relative to one another, which can be fastened on a hinge bearer (11 or 12), characterized in that at least one hinge wing (1) is adjustable transversely to its installation plane (17) by at least one adjustment means disposed so as to be height-offset, which can be fastened in the hinge bearer (11) of the hinge wing (1) transversely to its installation plane (17).

2. Hinge as claimed in claim 1, characterized in that as adjustment means two setting screws (21a, 21b) are provided which form at the front face one support face (23) each for the hinge wing (1) and are accessible through bores or slots (24a or 24b) of the hinge wing (1).

3. Hinge as claimed in claim 2, characterized in that the hinge wing (1) is provided with a setting element (16) for the lateral adjustment of the hinge wing (1) in its installation plane (17), wherein the setting screws (21a, 21b) are accessible through slots (24a, 24b) of the hinge wing (1) directed in the adjustment direction of the setting element (16).

4. Hinge as claimed in claim 2 or 3, characterized in that the setting screws (21a, 21b) are implemented as countersunk screws with flat screw heads (23).

5. Hinge as claimed in claim 4, characterized in that the setting screws (21a, 21b) are implemented as wood screws which can be screwed directly into the hinge bearer (11).

6. Hinge as claimed in claim 4, characterized in that the setting screws (21a, 21b) can be screwed into metal or plastic bushings which are set into the hinge bearer (11).

7. Hinge as claimed in one of the preceding claims 1 to 6, characterized in that at least one further setting screw is provided which can be screwed into the hinge bearer (11) transversely to the installation plane (17) of hinge wing (1).

8. Hinge as claimed in one or several of claims 1 to 7, characterized in that the setting screws (21a, 21b) in the installed state are disposed symmetrically with respect to the center axis of hinge wing (1).
